(19) United States
(12) Patent Application Publication
(10) Pub. No.: US 2012/0057200 A1
(43) Pub. Date: Mar. 8, 2012

(54) PRINTER

(75) Inventor: Hajime Yamamoto, Shizuoka (JP)

(73) Assignee: TOSHIBA TEC KABUSHIKI KAISHA, Tokyo (JP)

(21) Appl. No.: 13/223,775

(22) Filed: Sep. 1, 2011

(30) Foreign Application Priority Data
Sep. 3, 2010 (JP) 2010-198191
Jul. 13, 2011 (JP) 2011-154902

(51) Int. Cl. G06K 15/02

(52) U.S. Cl. 358/1.15

(57) ABSTRACT

A printer includes a loading unit configured to load a first printing medium including IC tags, which are data-readable/writable by wireless connection, and a printing surface formed on one side of the first printing medium. A conveying unit of the printer conveys the first printing medium, which is being drawn from the loader, along a conveyance path. A wireless reader/writer of the printer is configured to read/write data from/on the IC tags by wireless data communication between the IC tags provided in the first printing medium in the course of conveying the first printing medium. A control unit of the printer, at a point of time when printing on the first printing medium is completed, controls the wireless reader/writer to write information on the number of printing media printed on an IC tag included in a second printing medium subsequent to the first printing medium.

### CROSS-REFERENCE TO RELATED APPLICATIONS

This application is based upon and claims the benefit of priority from Japanese Patent Application Nos. 2011-154902 and 2010-198191, filed on Jul. 13, 2011 and Sep. 3, 2010, respectively, the entire contents of which are incorporated herein by reference.

### FIELD

Embodiments described herein relate generally to a printer.

### BACKGROUND

In a conventional printer, a printing medium such as a label paper including labels attached on a backing sheet in predetermined intervals is wound into a roll shape, which is loaded into a loading unit. The labels may include IC tags on which data is read/written from/to by wireless connection.

In such a printer, data is read/written from/to the IC tags contained in the labels by a wireless reader/writer while the label paper is being continuously conveyed from the loader and printed by means of a printing unit.

However, as the label paper is consumed and the remaining amount of the label paper is reduced, the remaining amount is monitored by a sensor. If the sensor detects that the amount is equal to or less than a predetermined value, a user is prompted to replace the label paper with a new one.

One exemplary method of detecting the amount of the label paper includes detecting a near-end of the paper by detecting a diameter of the paper roll from the side thereof by means of a detection sensor. Another exemplary method includes counting and recording the number of printing media printed up to a certain point of time in a printer.

However, the former method can only detect the near-end of the label paper, which results in inaccurate detection of the amount of the label paper. In the latter method, if the current label paper is replaced with a new label paper in the loader in the course of performing printing in the printer, the amount of the current label paper may not be correctly detected, which makes it difficult to properly monitor the amount and manage the usage of the label paper.

### BRIEF DESCRIPTION OF THE DRAWINGS

FIG. 1 is a side sectional view of a printer according to one embodiment.

FIG. 2 is a plan view showing a positional relationship between a wireless reader/writer and a label paper.

FIG. 3 is a side sectional view showing a positional relationship between the wireless reader/writer and the label paper.

FIG. 4 is a block diagram showing a control system of the printer.

FIG. 5 is a flow chart showing a printing operation of the printer.

FIG. 6 is a view showing a state where a plurality of labels is arranged between a thermal head and the wireless reader/writer on a label paper.

FIG. 7 is a view showing a state of feedbacking the label paper.

### DETAILED DESCRIPTION

According to one embodiment, a printer includes a loading unit configured to load a first printing medium including an IC tag, which is data-readable/writable by wireless communication, and a printing surface formed on one side of the first printing medium. The printer further includes a conveying unit configured to convey the first printing medium, which is being drawn from the loader, along a conveyance path, and a printing unit configured to print on the printing surface of the first printing medium in the conveyance path. A wireless reader/writer of the printer is configured to read/write data from/on the IC tags by wireless data communication with the IC tag provided in the first printing medium in the course of conveying the first printing medium. A control unit of the printer is configured to, if printing on the first printing medium is completed, control the wireless reader/writer to write information on the number of printing media printed on an IC tag included in a second printing medium subsequent to the first printing medium. The control unit monitors the number of printing media by controlling the wireless reader/writer to read the information on the number of printing media printed on from the second printing medium when the second printing medium is unloaded from the loading unit and re-loaded thereto.

Embodiments will now be described in detail with reference to the drawings.

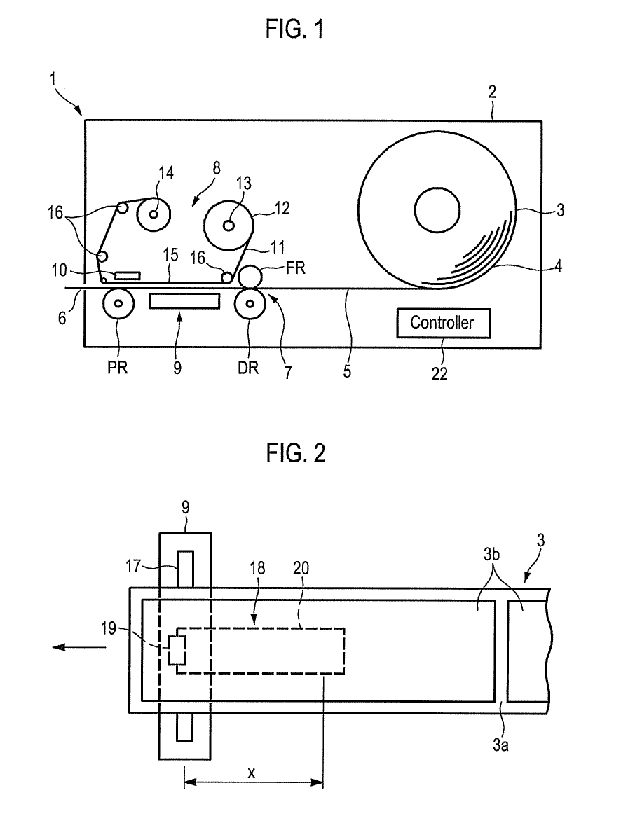

FIG. 1 is a side sectional view of a printer 1 according to one embodiment.

The printer 1 has a rectangular housing 2 including a paper holder 4 as a loading unit configured to accommodate a label paper 3 wound into a roll shape in such a manner that the label paper 3 can be conveyed along a predetermined conveyance path 5. The label paper 3 accommodated in the paper holder 4 is conveyed and guided along the conveyance path 5 and is discharged out of an outlet 6. The conveyance path 5 is formed in a substantially straight line between the paper holder 4 and the outlet 6. On the conveyance path 5 are arranged a paper conveying unit 7 as a medium conveying means, a printing unit 8 as a printing means, and a wireless reader/writer 9.

The paper conveying unit 7 includes a driving roller DR and driven roller FR opposing each other with the conveyance path 5 interposed therebetween, and a platen roller PR (which will be described later) provided in the printing unit 8.

In the conveyance path 5, the driving roller DR and driven roller FR are arranged at the upstream of the platen roller PR in a conveyance direction of the label paper 3. The driving roller DR and driven roller FR are driven to rotate by a driving motor (not shown) and generate power to convey the label paper 3.

The driven roller FR abuts the driving roller DR via the conveyance path 5 and is configured to effectively transfer rotation power of the driving roller DR to the label paper 3.

A thermal head 10 (which will be described later) constituting the printing unit 8 has a similar function to the driven roller FR. That is, the thermal head 10 abuts the platen roller PR via the conveyance path 5 and is configured to effectively transfer rotation power of the platen roller PR to the label paper 3.

In addition, as shown in FIG. 2, the label paper 3 has a roll structure in which a plurality of labels 3b as printing media are attached to an elongated backing sheet 3a at predetermined intervals. The label paper 3 is wound into a roll shape, so that the labels 3b attached thereto are facing toward an inner side of the roll. Surfaces of the labels 3b correspond to printing surfaces of the printing media.

As noted above, the printing unit 8 includes the platen roller PR and the thermal head 10 as its main elements. The thermal head 10 is a line thermal head having a plurality of heating elements (not shown) arranged in a row and performs a thermal transfer type printing operation to transfer ink from an ink ribbon 11 onto the labels 3b by selectively heating the heating elements.

The printing unit 8 includes a ribbon feeding mechanism 12 having a ribbon feeding shaft 13 for winding and holding the ink ribbon 11 and a ribbon winding shaft 14 for winding the ink ribbon 11. The ribbon feeding mechanism 12 is configured to draw the ink ribbon 11 wound and held by the ribbon feeding shaft 13 so that the drawn ink ribbon 11 passes between the platen roller PR and the thermal head 10 and is then wound around the ribbon winding shaft 14.

The ribbon feeding mechanism 12 is further provided with a plurality of guide rollers 16 to form a predetermined ribbon conveyance path 15 of the ink ribbon 11.

The ribbon winding shaft 14 is rotatably driven by a driving motor (not shown), similar to the driving roller DR and the platen roller PR, to wind the ink ribbon 11 being drawn from the ribbon feeding shaft 13.

The wireless reader/writer 9 is interposed between the driving roller DR and the platen roller PR along the conveyance path 5 and performs near field wireless communication with IC chips using RFID technology. For wireless communication purposes, the wireless reader/writer 9 includes an antenna 17 (see FIG. 2) for near field wireless communication. In one embodiment, the wireless reader/writer 9 performs wireless communication using a passive electromagnetic induction method.

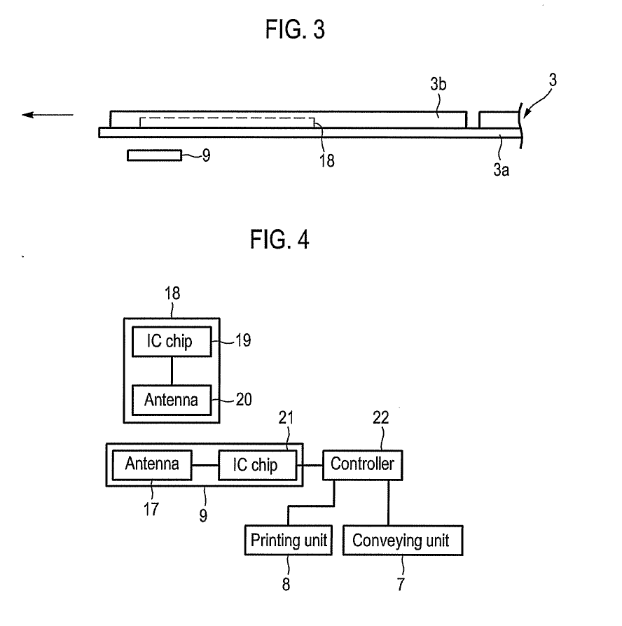

FIG. 2 is a plan view showing a positional relationship between a tag antenna 20 of an IC tag 18 (contained in the label paper 3) and an antenna 17 of the wireless reader/writer 9, and FIG. 3 is a side sectional view thereof.

The IC tag 18 is embedded in each label 3b of the label paper 3. The IC tag 18 includes the tag antenna 20 connected to an IC chip 19. The IC chip 19 is formed by an integrated circuit including a processor, a memory and a near field wireless communication circuit (not shown). The tag antenna 20 is configured to realize near field wireless communication performed by the IC chip 19.

FIG. 4 is a block diagram showing a control system of the printer 1 according to one embodiment.

In FIG. 4, reference numeral 22 denotes a controller configured to control the entire operation of the printer 1. The wireless reader/writer 9 includes the antenna 17 and an IC chip 21. The controller 22 controls the IC chip 21 of the wireless reader/writer 9 and the printing unit 8 to perform printing on the surface of the labels 3b.

The IC tag 18 includes the antenna 20 and the IC chip 19 provided with a memory for storing IDs (identifications) and other data.

The IC chip 21 of the wireless reader/writer 9 writes/reads information to/from the IC tag 18 via the antenna 17.

Specifically, a transmission signal from the IC chip 21 of the wireless reader/writer 9 is radiated in an electromagnetic waveform from the antenna 17. When a signal is received by the antenna 20 of the IC tag 18, this signal is transmitted to the IC chip 19 functioning as a transmission/reception unit. The IC chip 19 extracts information from the received signal and performs a predetermined operation based on the extracted information.

In addition, when the IC chip 19 of the IC tag 18 performs transmission, information is transmitted from the antenna 20 to the IC chip 21 via the antenna 17 of the wireless reader/writer 9.

The above-described controller 22 is configured to control a paper conveyance operation of the paper conveying unit 7. Specifically, when a first label 3b is printed with information by means of the thermal head 10, a second label 3b located subsequent to the first label 3b may not yet be printed but positioned out of range of a wireless communication coverage of the wireless reader/writer 9. In this case, the controller 22 controls the driving roller DR and the platen roller PR to rotate in the reverse direction so that the label paper 3 is fed back and the second label 3b faces the wireless reader/writer 9 within the range of wireless communication coverage.

In addition, the controller 22 controls the wireless reader/write 9 to write the number of printed labels on the IC chip 19 of the IC tag 18. Specifically, when the first label 3b is printed with information by means of the thermal head 10, the controller 22 controls the wireless reader/writer 9 to record the number of labels printed up to this point in time on the IC chip 19 of the IC tag 18 of the second label 3b, which is not yet printed, by wireless communication connection.

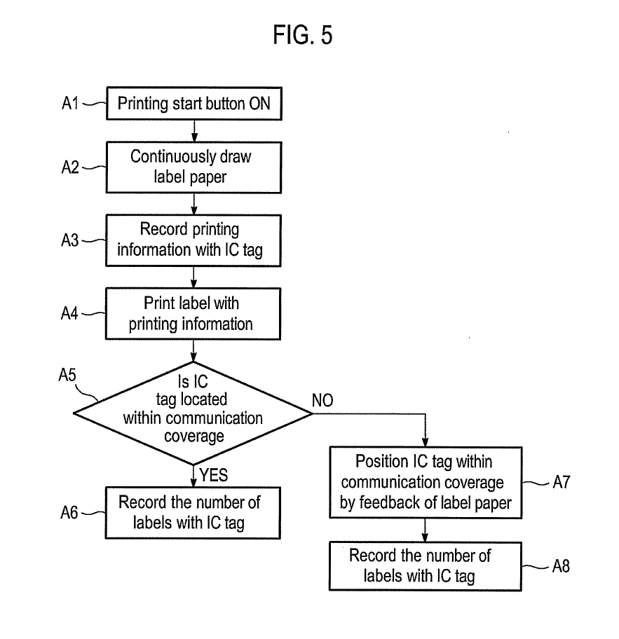

Next, the printing operation of the above-configured printer will be described with reference to FIG. 5.

If a printing start button (not shown) is pressed (Act A1), the label paper 3 begins to be continuously drawn from the paper holder 4 (Act A2). Printing information is recorded on the IC tag 18 contained in a label 3b of the continuously drawn label paper 3 by means of the wireless reader/writer 9 (Act A3). Thereafter, if the label 3b of the label paper 3 reaches a position where the printing unit 8 is provided, a printing surface of the label 3b is printed with the printing information by means of the thermal head 10 (Act A4).

Thereafter, it is determined whether or not the IC tag 18 of a label 3b, which is subsequent to the printed label 3b and is not yet printed, is located within the range of wireless communication coverage of the wireless reader/writer 9 (Act A5).

If it is determined that the IC tag 18 is located within the range of wireless communication coverage, the wireless reader/writer 9 sets the number of printed labels to “1” on the IC tag 18 of the subsequent label 3b (Act A6).

Otherwise, if it is determined that the IC tag 18 is not located within the range of wireless communication coverage, the controller 22 performs a positioning control to drive the driving roller DR and the platen roller PR to rotate in the reverse direction so that the label paper 3 is fed back by a certain distance, such that the IC tag 18 of the label 3b, which is subsequent to the printed label 3b, is positioned within the range of communication coverage of the wireless reader/writer 9 (Act A7). After performing the above positioning control of the label paper 3, the number of labels printed by the wireless reader/writer 9 is recorded on the IC tag 18 of the subsequent label 3b is set to “1” (Act A8).

Thereafter, the printing operation continues to be sequentially performed on the labels 3b and, in the course of performing the printing operation, the number of printed labels recorded on the IC tags 18 of labels 3b, which are subsequent to corresponding printed labels 3b but not yet printed, are respectively set to “2,” “3,” “4,” . . . .

The information recorded on the IC tags 18 may include, but not limited thereto, command information on the number of labels. Alternatively, the total number of labels and the number of printed labels may be recorded on the IC tags 18. As another alternative, the number of labels, which corresponds to a difference between the number of actually printed labels and the total number of labels, may be recorded on the IC tags 18.

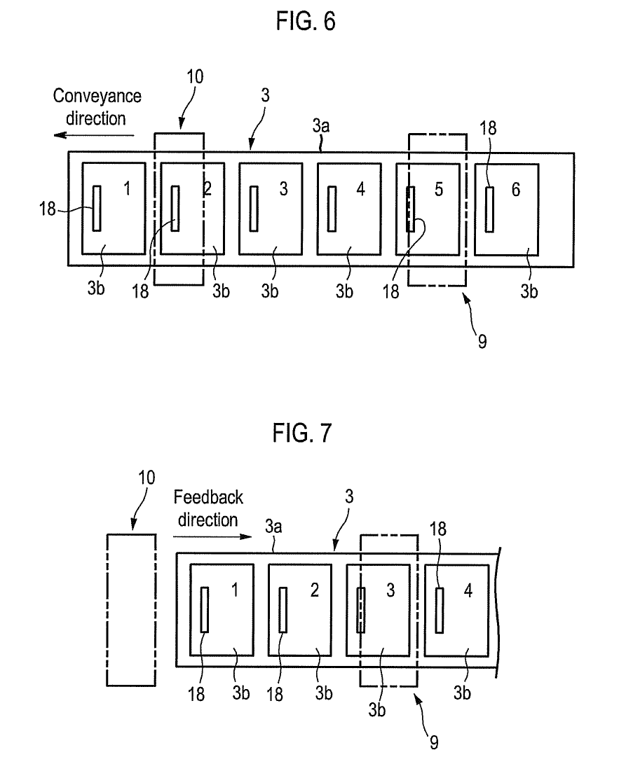

In the feedback operation of the label paper 3 in Act A7, for example, if the thermal head 10 is significantly spaced apart from the wireless reader/writer 9, a plurality of (for example, 2) labels 3b may exist between the thermal head 10 and the wireless reader/writer 9, as shown in FIG. 6. Inaccuracy in recording the number of printed labels may be occur if the number of labels printed by means of the thermal head 10 is recorded on the IC tags 18 of the labels 3b facing the wireless reader/writer 9.

That is, in the example shown in FIG. 6, when a second label 3b is printed by means of the thermal head 10, the number of printed labels recorded on the IC tag 18 of a fifth label 3b becomes “2.” In this case, third and fourth printed labels 3b are not incorporated in the number of printed labels recorded on the IC tag 18 of the fifth label 3b.

To avoid this problem, after printing the second label 3b by means of the thermal head 10, a positioning control is performed to feedback the label paper 3, such that the third label 3b is positioned to face the wireless reader/writer 9 within the range of communication coverage thereof, as shown in FIG. 7. After performing the positioning control, the number of printed labels is recorded on the IC tag 18 of the third label 3b by means of the wireless reader/writer 9. This allows correct recording of the number of printed labels on the IC tag 18 even when one or more labels 3b exists between the thermal head 10 and the wireless reader/writer 9.

As the printing operation continues to spend the label paper 3 and the amount thereof is reduced, for example, there is the case where the current roll of the label paper 3 held by the paper holder 4 is replaced with a new roll of label paper when about, for example, half the amount of the label paper 3 is consumed. In another case, the label paper 3 once taken out of the paper holder 4 is later re-loaded into the paper holder 4.

In these cases, after loading the label paper 3 into the paper holder 4, the label paper 3 is conveyed to a position of the wireless reader/writer 9. At this time, the number of printed labels recorded on the IC tag 18 of the label 3b is read out by means of the wireless reader/writer 9. Then, this read information is transmitted to the controller 22. For example, if the read number of printed labels is “50,” it is determined that 50 labels 3b have been already consumed, or if the read number of labels is “50,” it is determined that another 50 labels 3b are ready to be printed.

According to this embodiment, even when a roll of label paper 3 which has been partially consumed is re-loaded into the paper holder 4, the number of already printed labels and/or the number of labels which is not yet printed can be determined. This allows quick and efficient management of the number of labels.

It has been illustrated in the above first embodiment that, if there exists any label 3b between the thermal head 10 and the wireless reader/writer 9, the label paper 3 is fed back such that, for example, the third label 3b faces the wireless reader/writer 9 and the correct number of printed labels, “2,” is recorded on the IC tag 18 of the third label 3b. In a second embodiment, the recording of the correct number of labels on the IC tag 18 can be performed without performing a feedback operation of the label paper 3.

Specifically, assuming that the total number of labels is Z, the number of printed labels is X, a correction value (the number of labels existing between the thermal head 10 and the wireless reader/writer 9) is P and the number of labels is Y, the number of labels is calculated according to an equation, Y=Z−(X+P).

For example, if the total number Z of labels is 100, the number X of printed labels is 2, and the correction value P is 2, the number Y of labels=100−(2+2)=96. Accordingly, the wireless reader/writer 9 records the number of labels, “96,” on the IC tag 18 of the fifth label 3b facing the wireless reader/writer 9, as shown in FIG. 6.

According to the second embodiment, the correct number of labels, “96,” can be recorded on the IC tag 18 of the label 3b without performing a feedback operation of the label paper 3. Therefore, the recording of the number of labels for each label can be performed without performing a feedback operation. This reduces the overall printing time, which may result in improved throughput efficiency.

It has been illustrated in the above first and second embodiments that, whenever the labels 3b are printed one by one, the number of printed labels (and/or the number of labels) is recorded on the IC tag 18 of a subsequent label which is not yet printed. However, the present disclosure is not limited thereto but the number of printed labels (and/or the number of labels) may be recorded once after completing the printing of a predetermined number of labels (lots) or after completing a daily printing task.

Furthermore, the recording of the number of printed labels (and/or the number of labels) may be selectively performed by a user, e.g., through a pop-up display, when a series of printing operations over a system of a printer network is ended or when a daily printing task is completed. In another example, the number of printed labels (and/or the number of labels) may be automatically recorded when the operation of the system is ended.

The above embodiments are only presented by way of example and but are not intended to limit the scope of the disclosure. Although it has been illustrated in the above embodiments that the printing operation is performed by heating the thermal head to transfer ink of the ink ribbon into the label paper, the printing operation may be performed by thermally coloring a thermal printing paper used as a printing medium by means of the thermal head.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, or can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a loader configured to load a first printing medium including an IC tag, which is data-readable/writable by wireless communication, and a printing surface formed on one side of the first printing medium;
a conveying unit configured to convey the first printing medium being delivered from the loader, along a conveyance path;
a printing unit configured to print on the printing surface of the first printing medium in the conveyance path;
a wireless reader/writer configured to read/write data from/on the IC tags by wireless data communication with the IC tag included in the first printing medium being conveyed along the conveyance path; and
a control unit configured to control the wireless reader/writer, if printing on the first printing medium is completed, to record information on the number of printing media which have been printed on, up to the first printing medium, on an IC tag of a second printing medium which is subsequent to the first printing medium and is not yet printed.

2. The printer of claim 1, wherein the control unit monitors the number of remaining printing media by controlling the wireless reader/writer to read the information on the number of printing media printed on from the second printing medium when the second printing medium is re-loaded into the loading unit.

3. The printer of claim 1, wherein the information on the number of printing media printed on is recorded whenever each printing medium is printed.

4. The printer of claim 1, wherein the information on the number of printing media printed on is recorded whenever a predetermined number of printing media is recorded.

5. The printer of claim 1, wherein the wireless reader/writer is placed upstream of the printing unit in a conveyance direction of the printing medium, and
wherein, if the IC tag of the second printing medium is not positioned within a range of communication coverage of the wireless reader/writer, the control unit controls the conveying unit to convey the second printing medium in a direction reverse to the conveyance direction such that the IC tag of the second printing medium is positioned within the range of communication coverage of the wireless reader/writer.

6. The printer of claim 1, wherein, assuming that the total number of printing media loaded in the loader is Z, the number of printing media existing between the wireless reader/writer and the printing unit is P, and the number of printing media printed by the printing unit is X, the number of printing media is determined according to an equation Z−(X+P) and is recorded on an IC tag of a printing medium facing the wireless reader writer.

7. The printer of claim 1, wherein the printing media include labels attached to an elongated backing sheet at predetermined intervals along a longitudinal direction of the backing sheet and are loadable in the loader with the backing sheet wound into a roll shape.

8. A method for detecting an amount of a printing medium in a printer having a printing unit and a wireless reader/writer, the method comprising:
conveying a first printing medium including an IC tag, which is data-readable/writable by wireless communication, and a printing surface formed on one side of the printing medium, the first printing medium being delivered from a loader along a conveyance path;
printing on the printing surface in the conveyance path; and
if printing on the printing surface of the first printing medium is completed, controlling a wireless reader/writer to record information on the number of printing media which have been printed on, up to the first printing medium, on an IC tag of a second printing medium which is subsequent to the first printing medium and is not yet printed.

9. The method of claim 8, further comprising:
reading information on the number of printing media printed on by means of the wireless reader/writer when a printing medium having an IC tag storing the information on the number of printing media printed on is re-loaded.

10. The method of claim 8, wherein the information on the number of printing media printed on is recorded whenever each printing medium is printed.

11. The method of claim 8, wherein the information on the number of printing media printed on is recorded whenever a predetermined number of printing media is recorded.

12. The method of claim 8, wherein the wireless reader/writer is placed upstream of the printing unit in a conveyance direction of the printing medium, the method further comprising:
if the IC tag of the second printing medium is not positioned within a range of communication coverage of the wireless reader/writer, conveying the second printing medium in a direction reverse to the conveyance direction such that the IC tag of the second printing medium is positioned within the range of communication coverage of the wireless reader/writer.

13. The method of claim 8, further comprising:
determining the number of printing media according to an equation Z−(X+P), wherein Z is the total number of printing media loaded in the loader, P is the number of printing media existing between the wireless reader/writer and the printing unit, and X is the number of printing media printed by means of the printing unit; and
recording the number of printing media on an IC tag of a printing medium facing the wireless reader writer.

14. The method of claim 8, wherein the printing media include labels attached to an elongated backing sheet at predetermined intervals along a longitudinal direction of the backing sheet and are loadable in the loader with the backing sheet wound into a roll shape.
